(19) United States
(12) Patent Application Publication
(10) Pub. No.: US 2015/0350452 A1
(43) Pub. Date: Dec. 3, 2015

(54) METHOD AND SYSTEM FOR MANAGING DROPPED CALL OPERATIONS

(71) Applicant: VONAGE NETWORK LLC, Holmdel, NJ (US)

(72) Inventor: Jaya Meghani, Old Bridge, NJ (US)

(73) Assignee: VONAGE NETWORK LLC, Holmdel, NJ (US)

(21) Appl. No.: 14/291,674

(22) Filed: May 30, 2014

(51) Int. Cl. H04M 7/00; H04W 76/02; H04L 12/911; H04L 29/06; H04W 4/24; H04M 15/00

(52) U.S. Cl. CPC H04M 7/0084; H04W 4/24; H04M 15/8207; H04M 15/56; H04L 47/746; H04L 65/1006; H04W 76/028

(57) ABSTRACT

Methods and systems for managing dropped call operations are provided here. In some embodiments a method for managing dropped call operations may include receiving a first notification of a change in network connectivity during a communication session between a first user device and a second user device; receiving a second notification of a change in network connectivity; generating communication data for the communication session based on a time that the first notification of a change in network connectivity was received; and transmitting the communication data to a service provider.

### BACKGROUND

1. Field

Embodiments of the present invention relate generally to communication systems and, more particularly, to methods and systems for managing dropped call operations in a Voice over Internet Protocol (VoIP) application.

2. Description of the Related Art

In a Session Initiation Protocol (SIP) communication between two or more parties, the party that hangs up sends a BYE message to the other parties. The VoIP provider knows from the BYE message that the call is over and therefore, when to stop billing. However, a call may drop due to a loss in network connectivity, for example, when a user enters a “dead zone”. In such case, the user device cannot tear down the call gracefully through the use of the BYE message. As such, the VoIP provider does not know the call has terminated. In some instances, even the user is not aware that the call has terminated, for example, if the user's device loses network connectivity while the user is on hold.

The user device may regain network connectivity, allowing the user to attempt to place a call. However, if the user is not entitled to place concurrent calls, the user is prevented from making the call because the service provider records indicate that the user device has an active call. If the user is entitled to make concurrent calls, the user may be double-billed.

Currently, a VoIP provider may maintain TCP/IP connections with the user devices that are configured to “ping” the devices periodically, for example, every ten (10) minutes. A loss of connection to one of the parties may signal to the VoIP provider that the call has terminated. Again, if the user device regains connectivity before the VoIP provider is aware of the loss of connectivity, the user may be prevented from making a call or double-billed.

In view of the foregoing, there exists a need in the art for improved methods and systems for managing dropped call operations in a Voice over Internet Protocol (VoIP) application.

### SUMMARY

Methods and systems for managing dropped call operations are provided here. In some embodiments a method for managing dropped call operations may include receiving a first notification of a change in network connectivity during a communication session between a first user device and a second user device; receiving a second notification of a change in network connectivity; generating communication data for the communication session based on a time that the first notification of a change in network connectivity was received; and transmitting the communication data to a service provider.

In some embodiments, a method for managing dropped call operations may include receiving communication data for at least one dropped communication from a user device; verifying the at least one dropped communication has an active status; and at least one of tearing down the at least one dropped communication, removing the at least one communications from a list of active communications in a current communications memory, or providing billing information for a communication session associated with the at least one dropped communication to a billing server.

In some embodiments, a system for managing dropped call operations may include a mobile application configured to: receive a first notification of a change in network connectivity during a communication session between a first user device and a second user device; receive a second notification of a change in network connectivity; generate communication data for the communication session based on a time that the first notification of a change in network connectivity was received; and transmit the communication data to a service provider.

Other and further embodiments of the present invention are described below.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a block diagram of a telecommunication network, according to one or more embodiments of the invention;

FIG. 2 depicts a block diagram of a system for managing dropped call operations, according to one or more embodiments;

FIG. 3 depicts a method for managing dropped call operations, according to one or more embodiments; and

FIG. 4 depicts a computer system that can be utilized in various embodiments of the present invention, according to one or more embodiments.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Embodiments of the present invention relate generally to improved methods and systems for managing dropped call operations in a Voice over Internet Protocol (VoIP) application. More specifically, embodiments of the present invention enable a mobile app, for example, a VoIP telecommunication application, to determine when one or more calls have dropped. When it is determined that one or more calls have dropped, a notification is sent to a service provider to tear down the dropped call and adjust billing for the call based on a time when the call was dropped. A user device receives an indication when a network connection is lost. The time of the loss of network connectivity is cached by the mobile app. When the mobile app receives an indication that the network connection has been restored, the mobile app determines which calls were active when the network connection was lost. A call is considered to be active if there is real-time communication between two devices. Such active calls may have a status of “active” indicating that the communication between devices is in progress. The mobile app generates a notification for each call that was active when the connection was lost that includes at least a call identifier, a start time of the call, and a time when the network connection was lost. The notification is sent to a service provider thereby instructing the service provider to tear down the call, update a database of current calls for the user, and create an accurate billing record for the call.

Some portions of the detailed description which follow are presented in terms of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

In the following description, the terms VOIP system, VOIP telephony system, IP system and IP telephony system are all intended to refer to a system that connects callers and that delivers data, text and video communications using Internet protocol data communications. Those of ordinary skill in the art will recognize that embodiments of the present invention are not limited to use with IP telephony systems and may also be used in other systems.

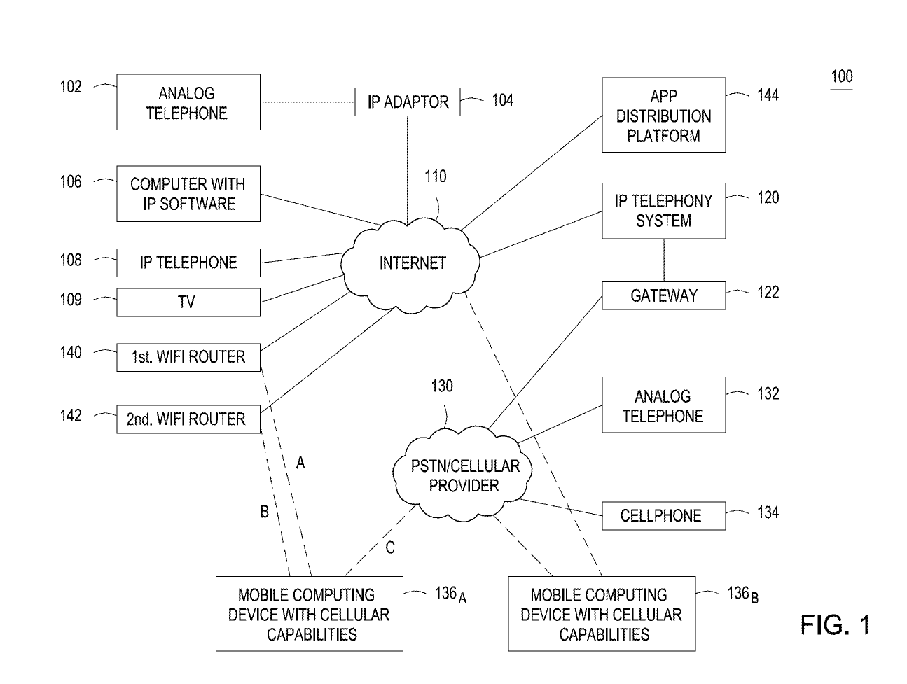

As illustrated in FIG. 1, a communications environment 100 is provided to facilitate IP enhanced communications. An IP telephony system 120 enables connection of telephone calls between its own customers and other parties via data communications that pass over a data network 110. The data network 110 is commonly the Internet, although the IP telephony system 120 may also make use of private data networks. The IP telephony system 120 is connected to the Internet 110. In addition, the IP telephony system 120 is connected to a publicly switched telephone network (PSTN) 130 via a gateway 122. The PSTN 130 may also be directly coupled to the Internet 110 through one of its own internal gateways (not shown). Thus, communications may pass back and forth between the IP telephony system 120 and the PSTN 130 through the Internet 110 via a gateway maintained within the PSTN 130.

The gateway 122 allows users and devices that are connected to the PSTN 130 to connect with users and devices that are reachable through the IP telephony system 120, and vice versa. In some instances, the gateway 122 would be a part of the IP telephony system 120. In other instances, the gateway 122 could be maintained by a third party.

Customers of the IP telephony system 120 can place and receive telephone calls using an IP telephone 108 that is connected to the Internet 110. Such an IP telephone 108 could be connected to an Internet service provider via a wired connection or via a wireless router. In some instances, the IP telephone 108 could utilize a packet-switched network of a cellular telephone system to access the Internet 110.

Alternatively, a customer could utilize an analog telephone 102 which is connected to the Internet 110 via a telephone adapter 104. The telephone adapter 104 converts analog signals from the telephone 102 into data signals that pass over the Internet 110, and vice versa. Analog telephone devices include but are not limited to standard telephones and document imaging devices such as facsimile machines. A configuration using a telephone adapter 104 is common where the analog telephone 102 is located in a residence or business. Other configurations are also possible where multiple analog telephones share access through the same IP adaptor. In those situations, all analog telephones could share the same telephone number, or multiple communication lines (e.g., additional telephone numbers) may provisioned by the IP telephony system 120.

In addition, a customer could utilize a soft-phone client running on a computer 106 or a television 109 to place and receive IP based telephone calls, and to access other IP telephony systems (not shown). The computer 106 may be a personal computer (PC), a tablet device, a gaming system, and the like. In some instances, the soft-phone client could be assigned its own telephone number. In other instances, the soft-phone client could be associated with a telephone number that is also assigned to an IP telephone 108, or to a telephone adaptor 104 that is connected one or more analog telephones 102.

users of the IP telephony system 120 are able to access the service from virtually any location where they can connect to the Internet 110. Thus, a customer could register with an IP telephony system provider in the U.S., and that customer could then use an IP telephone 108 located in a country outside the U.S. to access the services. Likewise, the customer could also utilize a computer outside the U.S. that is running a soft-phone client to access the IP telephony system 120.

A third party using an analog telephone 132 which is connected to the PSTN 130 may call a customer of the IP telephony system 120. In this instance, the call is initially connected from the analog telephone 132 to the PSTN 130, and then from the PSTN 130, through the gateway 122 to the IP telephony system 120. The IP telephony system 120 then routes the call to the customer's IP telephony device. A third party using a cellular telephone 134 could also place a call to an IP telephony system customer, and the connection would be established in a similar manner, although the first link would involve communications between the cellular telephone 134 and a cellular telephone network. For purposes of this explanation, the cellular telephone network is considered part of the PSTN 130.

In the following description, references will be made to an “IP telephony device.” This term is used to refer to any type of device which is capable of interacting with an IP telephony system to complete an audio or video telephone call or to send and receive text messages, and other forms of communications. An IP telephony device could be an IP telephone, a computer running IP telephony software, a telephone adapter which is itself connected to a normal analog telephone, or some other type of device capable of communicating via data packets. An IP telephony device could also be a cellular telephone or a portable computing device that runs a software application that enables the device to act as an IP telephone. Thus, a single device might be capable of operating as both a cellular telephone that can facilitate voice based session calls, and an IP telephone that can facilitate data based session calls.

The following description will also refer to a mobile telephony device. The term “mobile telephony device” is intended to encompass multiple different types of devices. In some instances, a mobile telephony device could be a cellular telephone. In other instances, a mobile telephony device may be a mobile computing device, such as the APPLE IPHONE, that includes both cellular telephone capabilities and a wireless data transceiver that can establish a wireless data connection to a data network. Such a mobile computing device could run appropriate application software to conduct VoIP telephone calls via a wireless data connection. Thus, a mobile computing device, such as an APPLE IPHONE, a RIM BLACKBERRY or a comparable device running GOOGLE ANDROID operating system could be a mobile telephony device.

In still other instances, a mobile telephony device may be a device that is not traditionally used as a telephony device, but which includes a wireless data transceiver that can establish a wireless data connection to a data network. Examples of such devices include the APPLE IPOD TOUCH and the IPAD. Such a device may act as a mobile telephony device once it is configured with appropriate application software.

FIG. 1 illustrates that a mobile computing device with cellular capabilities 136A (e.g., a smartphone) is capable of establishing a first wireless data connection A with a first wireless access point 140, such as a WiFi or WiMax router. The first wireless access point 140 is coupled to the Internet 110. Thus, the mobile computing device 136A can establish a VOIP telephone call with the IP telephony system 120 via a path through the Internet 110 and the first wireless access point 140.

FIG. 1 also illustrates that the mobile computing device 136A can establish a second wireless data connection B with a second wireless access point 142 that is also coupled to the Internet 110. Further, the mobile computing device 136A can establish either a third wireless data connection C via a packet-switch network provided by a cellular service provider 130 using its cellular telephone capabilities, or establish a voice based session telephone call via a circuit-switched network provided by a cellular service provider 130. The mobile computing device 136A could also establish a VoIP telephone call with the IP telephony system 120 via the second wireless connection B or the third wireless connection C.

Although not illustrated in FIG. 1, the mobile computing device 136A may be capable of establishing a wireless data connection to a data network, such as the Internet 110, via alternate means. For example, the mobile computing device 136A might link to some other type of wireless interface using an alternate communication protocol, such as the WIMAX standard. In the embodiments described above, a device may act as a mobile telephony device once it is configured with appropriate application software that may be downloaded from an app distribution platform 144. For example, mobile computing device 136A may download a VOIP mobile app from app distribution platform 144 and install the VOIP mobile app on mobile computing device 136A.

Similarly, mobile computing device with cellular capabilities 136B may also be coupled to internet 110 and/or cellular service provider 130. In some embodiments, mobile computing device 136B may be connected to internet 110 via a WIFI or WIMAX connection, and the like, and can also establish a VOIP telephone calls with the IP telephony system 120 similar to mobile computing device 136A. In embodiments of the present invention, communications environment 100 may be used to establish voice based or data based telecommunications sessions between mobile computing device 136A and mobile computing device 136B, depending on various criteria associated with each of the mobile computing devices, as will be described below in more detail. In some exemplary embodiments described below, mobile computing devices 136A and 136B are on different service provider networks and communications between mobile computing devices 136A and 136B are “off-net” communications. When mobile computing devices 136A and 136B are on the same service provider network, communications between mobile computing devices 136A and 136B are considered “on-net” communications.

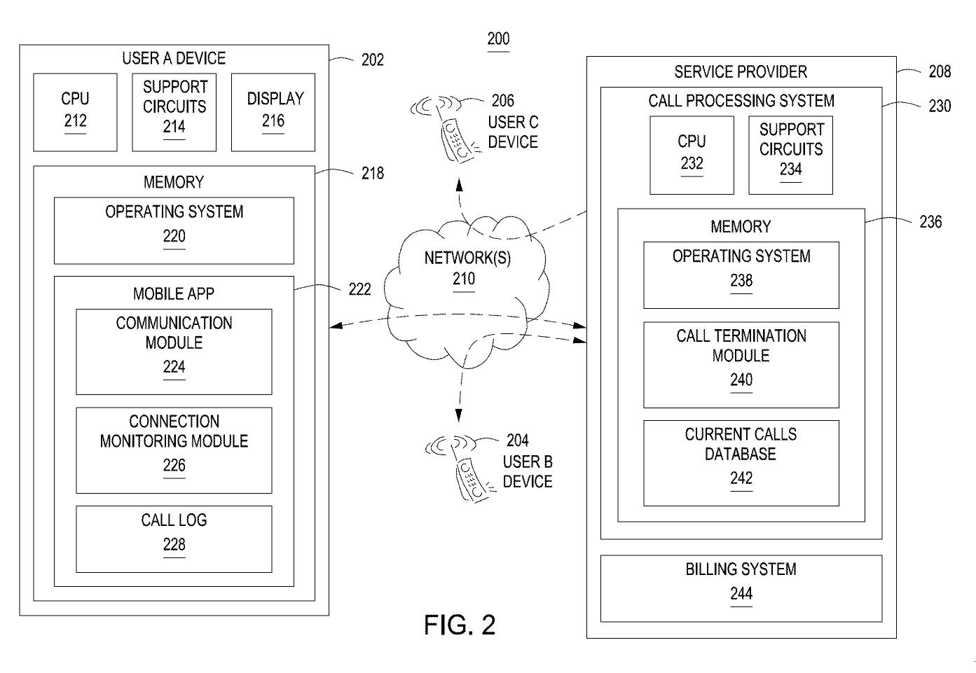

FIG. 2 depicts a block diagram of a system 200 for managing dropped call operations in accordance with embodiments presented herein. The system 200 includes at least one telecommunication service provider 208 that can provide telecommunication services to a plurality of end-user devices (e.g., such as user A device 202, user B device 204, and user C device 206) via one or more networks 210. Devices 202, 204, and 206 may include analog phone 102, a computer with IP software 106, IP telephone 108, and/or mobile computing device with cellular capabilities 136A, 136B, and the like, as shown in FIG. 1. The telecommunication service provider 208 may include IP telephone system 120 that facilitates on-net calls between user A device 202, user B device 204, and user C device 206.

The end-user devices (e.g., user A device 202, user B device 204, and user C device 206) comprise a Central Processing Unit (CPU) 212, support circuits 214, display 216, and memory 218. The CPU 212 may comprise one or more commercially available microprocessors or microcontrollers that facilitate data processing and storage. The various support circuits 214 facilitate the operation of the CPU 212 and include one or more clock circuits, power supplies, cache, input/output circuits, and the like. The memory 218 comprises at least one of Read Only Memory (ROM), Random Access Memory (RAM), disk drive storage, optical storage, removable storage and/or the like. In some embodiments, the memory 218 comprises an operating system (OS) 220, and a mobile app 222. The mobile app 222 may be a VoIP mobile telecommunications application provided by, or otherwise associated with, telecommunication service provider 208. The mobile app 222 may be downloaded from app distribution platform 144 and installed on user A device 202, user B device 204, and/or user C device 206. The mobile app 222 includes a communication module 224, a connection monitoring module 226, and a call log 228. The communication module 224 is designed to provide telecommunication services to the device. The connection monitoring module 226 is designed to process notifications received from the operating system 220 when a change in network connectivity is identified. The call log 228 includes calls placed by the user device in addition to a time when the call started/ended. The call log 228 may be used to identify calls that were made but were subsequently dropped. A call in the call log 228 that does not include an end time may identify a dropped call.

The operating system (OS) 220 generally manages various computer resources (e.g., network resources, file processors, and/or the like). The operating system 220 is configured to execute operations on one or more hardware and/or software modules, such as Network Interface Cards (NICs), hard disks, virtualization layers, firewalls and/or the like. Examples of the operating system 220 may include, but are not limited to, LINUX, MAC OSX, BSD, UNIX, MICROSOFT WINDOWS, 10S, ANDROID and the like.

The telecommunication service provider 208 may be a VoIP service provider network and includes a call processing system 230 and a billing system 244. In some embodiments, the call processing system 230 comprises a Central Processing Unit (CPU) 232, support circuits 234, and memory 236. The CPU 232 may comprise one or more commercially available microprocessors or microcontrollers that facilitate data processing and storage. The various support circuits 234 facilitate the operation of the CPU 232 and include one or more clock circuits, power supplies, cache, input/output circuits, and the like. The memory 236 comprises at least one of Read Only Memory (ROM), Random Access Memory (RAM), disk drive storage, optical storage, removable storage and/or the like. In some embodiments, the memory 236 comprises an operating system 238, a call termination module 240, and a current calls database 242. Although described herein as a database, those skilled in the art can appreciate that a record of current calls may be maintained in any memory structure, for example, a distributed cache or the like. The call termination module 240 is designed to handle the tearing down of calls that have been identified as dropped calls. The call termination module 240 is further designed to remove the call from the calls identified in the current calls database 242. The call termination module 240 is also designed to generate a billing record for the dropped call and provide it to the billing system 244. In some embodiments, the processes of the call processing system 230 may be distributed across two or more servers communicatively coupled to one another. In some embodiments, the billing system 244 may be disposed on a single server. In other embodiments, the call processing system 230 and the billing system 244 may each be separate servers communicatively coupled to one another.

The OS 238 generally manages various computer resources (e.g., network resources, file processors, and/or the like). The operating system 238 is configured to execute operations on one or more hardware and/or software modules, such as Network Interface Cards (NICs), hard disks, virtualization layers, firewalls and/or the like. Examples of the operating system 238 may include, but are not limited to, LINUX, MAC OSX, BSD, UNIX, MICROSOFT WINDOWS, 10S, ANDROID and the like.

The networks 210 comprise one or more communication systems that connect computers by wire, cable, fiber optic and/or wireless link facilitated by various types of well-known network elements, such as hubs, switches, routers, and the like. The networks 210 may include an Internet Protocol (IP) network 110, a public switched telephone network (PSTN) 130, or other mobile communication networks listed above, and may employ various well-known protocols to communicate information amongst the network resources.

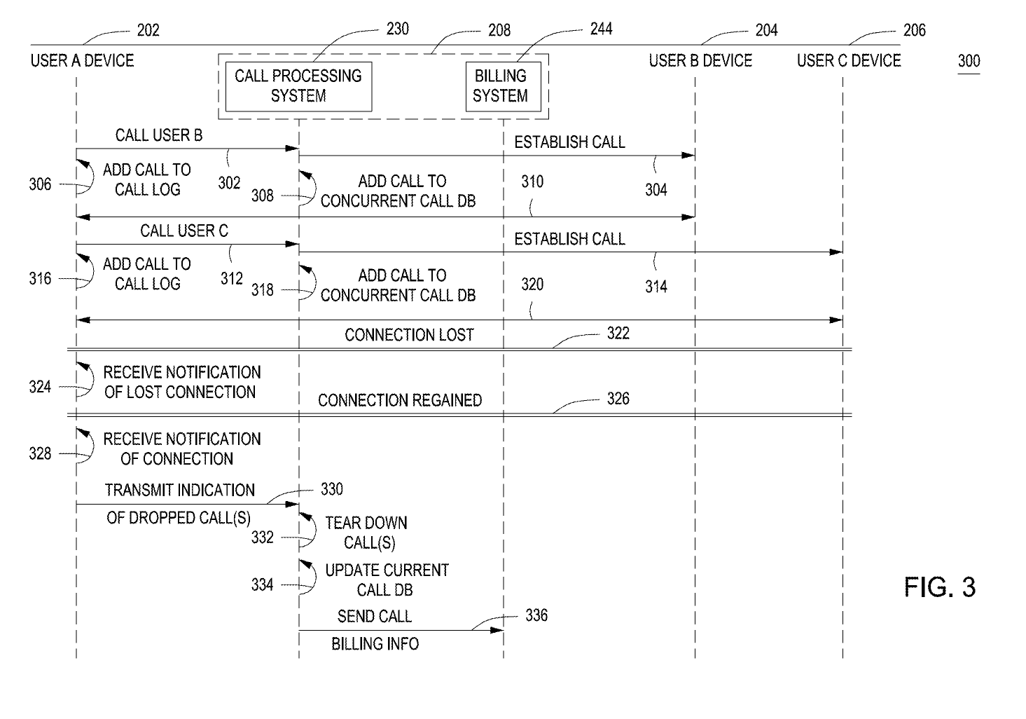

Referring to FIG. 3, a method 300 for managing dropped call operations begins at 302 where user A places a call to user B. In some embodiments, the call may be originated by a telecommunication device such as, for example, user A device 202 in FIG. 2. In attempting to establish the call with user B, a call request is sent to call processing system 230 to be processed at step 302. In a VoIP network, the call request oftentimes takes the form of a Session Initiation Protocol (SIP) INVITE message sent from user A device 202 to a call processing system 230. In a VoIP network, the call processing system 230 may be, for example, a SIP Proxy Network. The details and functionality of SIP can be found in the Internet Engineering Task Force (IETF) Request for Comments (RFC) Paper No. 3261 entitled, “SIP: Session Initiation Protocol” herein incorporated in its entirety by reference.

Call processing system 230 establishes a call between user A device 202 and user B device 204 at step 304. To accomplish this, in some embodiments, call processing system 230 (e.g., a SIP Proxy Network) may send a SIP INVITE message to user B device 204. User B device 204 responds with a SIP OK message. User A device 202 may respond with an SIP ACK message and the call between user A device 202 and user B device 204 is established. In some embodiments, establishing the telecommunication session between the user A device 202 and user B device 204 includes: (1) sending a first acknowledgement/call acceptance message in response to the call from user B device 204 to the call processing system 230, and (2) sending a second acknowledgement/call acceptance message from the call processing system 230 to user A device 202, to establish the call between the user A device 202 and user B device 204. In some embodiments, the first and second acknowledgement/call acceptance messages may include information in the header or the body of the message to inform user A device 202 that the call is being established with user B device 204. For example, in a VoIP system, the first and second acknowledgement/call acceptance messages may be SIP 200 OK messages. The SIP 200 OK messages may include a custom SIP header indicating that the call is being established with user B device 204.

The mobile app 222 adds the call to the call log 228 at step 306. The call processing system 230 adds the call to a concurrent call database 242 at step 308. In some embodiments, the telecommunication session established may be a real time transfer protocol (RTP) stream between the communication module 224 of the mobile app 222 disposed on user A device 202 and user B device 204. The telecommunication session continues at step 310.

While on the call with user B device 204, if the user is entitled by the service provider 208 to make concurrent calls, user A device 202 may place a second call. For example, user A device 202 may place the call with user B device 204 on hold and place a second call to user C device 206 or user A may add user C device 206 to the call with user B device 204.

The call processing system 230 verifies that user A may make concurrent calls and determines from the concurrent call database 242 that user A has not exceeded the allowable number of concurrent calls. When the call processing system 230 determines that user A may place the call to user C, the call processing system 230 establishes a call between user A device 202 and user C device 206 at step 314, similarly to how the call between user A device 202 and user B device 204 was established. In addition, the mobile app 222 adds the call to the call log 228 at step 316. The call processing system 230 adds the call to a concurrent call database 242 at step 318. The telecommunication session between user A device 202 and user C device 206 continues at step 320.

At step 322, a connection to the network is lost. When the connection to the network is lost, the mobile app 222 receives a notification from the operating system 220 at step 324. The notification indicates that a change in connectivity has occurred. For example, in 10S, a reachability application monitors the network state of an IOS device. When a change in the network state (e.g. connected to not connected or not connected to connected), the operating system 220 notifies the mobile app 222. Other operating systems, such as ANDROID, MS WINDOWS, and the like may use a similar types of reachability applications or provide access to application programming interface (API) calls that may be used to determine the reachability/network state of a telecommunication network. The connection monitoring module 226 caches the time that the connectivity was lost.

At step 326, the connection to the network is regained. When the connection to the network is regained, the mobile app 222 receives a notification from the operating system 220 at step 328. The notification indicates that a change in connectivity has occurred and may be come from a reachability application or API call.

The connection monitoring module 226 sends call data to the call processing system 230 at step 330. The connection monitoring module 226 accesses the call log 228 to identify dropped calls (i.e., calls that were active when the network connection was lost). A call is considered to be active if there is real-time communication between two devices. Such active calls may have a status of “active” indicating that the communication between devices is in progress. Calls that were active at the time of the loss of network connectivity include calls for which the user A device 202 did not send or receive a teardown request (e.g., a SIP BYE). In the present example, the call between user A device 202 and user B device 204 was dropped. In addition, the call between user A device 202 and user C device 206 was dropped.

In some embodiments, when the network connectivity is restored, the connection monitoring module 226 may prompt the user to redial or the user A device 202 to auto-redial calls that are identified as dropped.

For each identified call, the connection monitoring module 226 identifies call data, for example, a start time of the call, a time the call ended (i.e., time network connection was lost), a length of the call, a dialed number, a call identifier (e.g., SIP call-ID), caller number, and callee number for the identified call. The connection monitoring module 226 generates call data for the dropped calls and transmits the call data in a message to the call processing system 230 at step 330. The message may be sent out-of-band to the service provider 208. In some embodiments, out-of-band refers to the exchange of call control information, for example, which may be sent via a separate communication connection from the data or voice stream connections. In some embodiments, the call data may be sent via an SIP NOTIFY message, Hypertext Transfer Protocol (HTTP) message, or the like. In some embodiments, user A device 202 waits for an acknowledgement response from the service provider 208 before deleting data regarding the dropped calls.

When the call processing system 230 receives the dropped call data from user A device 202, as described above, the call processing system 230 may send an acknowledgement response to the user A device 202. The call processing system 230 then searches for the dropped call(s) in the current calls database 242 to ensure that the dropped call is still considered to be active and has not already been processed. The call processing system 230 then performs one or more of the following steps.

The call termination module 240 may teardown the dropped call(s) at step 332. The call processing system 230 may update the current calls database 242 to remove the dropped call(s) at 334. At 336, the call processing system 230 may generate and send call billing information to the billing system 244. In some embodiments, the call billing information is calculated per the time the call data is received by the call processing system 230. In some embodiments, the call billing is adjusted based on the time the network connectivity was lost on user A device 202.

The embodiments of the present invention may be embodied as methods, apparatus, electronic devices, and/or computer program products. Accordingly, the embodiments of the present invention may be embodied in hardware and/or in software (including firmware, resident software, micro-code, and the like), which may be generally referred to herein as a “circuit” or “module”. Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device. These computer program instructions may also be stored in a computer-usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer-usable or computer-readable medium may be, for example but not limited to, an electronic, magnetic, optical, electromagnetic, infrared, or semiconductor system, apparatus or device. More specific examples (a non exhaustive list) of the computer-readable medium include the following: hard disks, optical storage devices, magnetic storage devices, an electrical connection having one or more wires, a portable computer diskette, a random access memory (RAM), a read-only memory (ROM), an erasable programmable read-only memory (EPROM or Flash memory), an optical fiber, and a compact disc read-only memory (CD-ROM).

Computer program code for carrying out operations of the present invention may be written in an object oriented programming language, such as Java®, Smalltalk or C++, and the like. However, the computer program code for carrying out operations of the present invention may also be written in conventional procedural programming languages, such as the “C” programming language and/or any other lower level assembler languages. It will be further appreciated that the functionality of any or all of the program modules may also be implemented using discrete hardware components, one or more Application Specific Integrated Circuits (ASICs), or programmed Digital Signal Processors or microcontrollers.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present disclosure and its practical applications, to thereby enable others skilled in the art to best utilize the invention and various embodiments with various modifications as may be suited to the particular use contemplated.

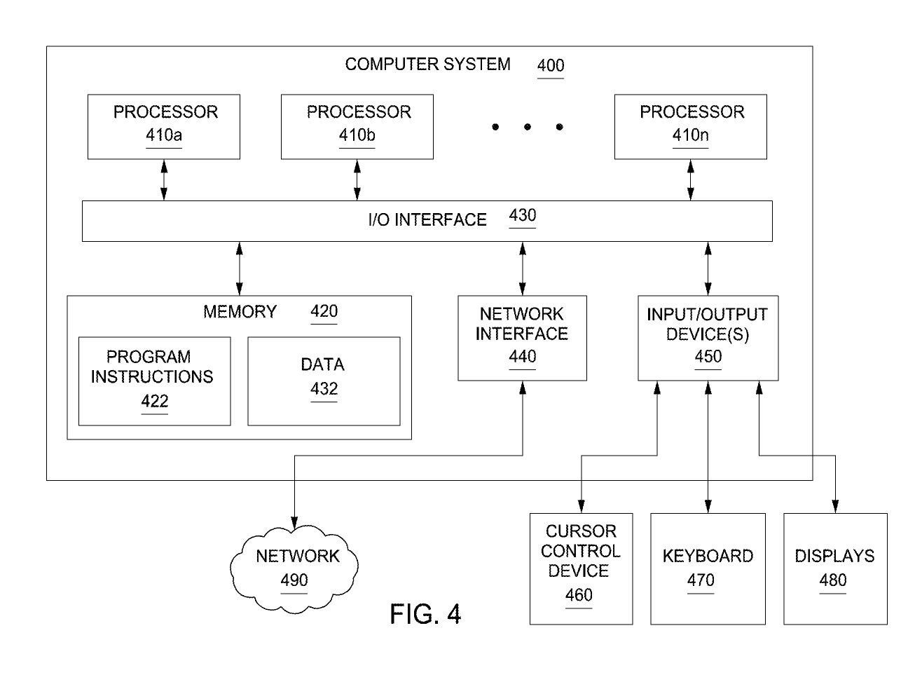

FIG. 4 depicts a computer system 400 that can be utilized in various embodiments of the present invention to implement the computer and/or the display, according to one or more embodiments.

Various embodiments of method and apparatus for organizing, displaying and accessing contacts in a contact list, as described herein, may be executed on one or more computer systems, which may interact with various other devices. One such computer system is computer system 400 illustrated by FIG. 4, which may in various embodiments implement any of the elements or functionality illustrated in FIGS. 1-3. In various embodiments, computer system 400 may be configured to implement methods described above. The computer system 400 may be used to implement any other system, device, element, functionality or method of the above-described embodiments. In the illustrated embodiments, computer system 400 may be configured to implement method 300 as processor-executable executable program instructions 422 (e.g., program instructions executable by processor(s) 410) in various embodiments.

In the illustrated embodiment, computer system 400 includes one or more processors 410a-410n coupled to a system memory 420 via an input/output (I/O) interface 430. Computer system 400 further includes a network interface 440 coupled to I/O interface 430, and one or more input/output devices 450, such as cursor control device 460, keyboard 470, and display(s) 480. In various embodiments, any of the components may be utilized by the system to receive user input described above. In various embodiments, a user interface may be generated and displayed on display 480. In some cases, it is contemplated that embodiments may be implemented using a single instance of computer system 400, while in other embodiments multiple such systems, or multiple nodes making up computer system 400, may be configured to host different portions or instances of various embodiments. For example, in one embodiment some elements may be implemented via one or more nodes of computer system 400 that are distinct from those nodes implementing other elements. In another example, multiple nodes may implement computer system 400 in a distributed manner.

In different embodiments, computer system 400 may be any of various types of devices, including, but not limited to, a personal computer system, desktop computer, laptop, notebook, or netbook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In various embodiments, computer system 400 may be a uniprocessor system including one processor 410, or a multiprocessor system including several processors 410 (e.g., two, four, eight, or another suitable number). Processors 410 may be any suitable processor capable of executing instructions. For example, in various embodiments processors 410 may be general-purpose or embedded processors implementing any of a variety of instruction set architectures (ISAs). In multiprocessor systems, each of processors 410 may commonly, but not necessarily, implement the same ISA.

System memory 420 may be configured to store program instructions 422 and/or data 432 accessible by processor 410. In various embodiments, system memory 420 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing any of the elements of the embodiments described above may be stored within system memory 420. In other embodiments, program instructions and/or data may be received, sent or stored upon different types of computer-accessible media or on similar media separate from system memory 420 or computer system 400.

In one embodiment, I/O interface 430 may be configured to coordinate I/O traffic between processor 410, system memory 420, and any peripheral devices in the device, including network interface 440 or other peripheral interfaces, such as input/output devices 450. In some embodiments, I/O interface 430 may perform any necessary protocol, timing or other data transformations to convert data signals from one component (e.g., system memory 420) into a format suitable for use by another component (e.g., processor 410). In some embodiments, I/O interface 430 may include support for devices attached through various types of peripheral buses, such as a variant of the Peripheral Component Interconnect (PCI) bus standard or the Universal Serial Bus (USB) standard, for example. In some embodiments, the function of I/O interface 430 may be split into two or more separate components, such as a north bridge and a south bridge, for example. Also, in some embodiments some or all of the functionality of I/O interface 430, such as an interface to system memory 420, may be incorporated directly into processor 410.

Network interface 440 may be configured to allow data to be exchanged between computer system 400 and other devices attached to a network (e.g., network 490), such as one or more external systems or between nodes of computer system 400. In various embodiments, network 490 may include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 440 may support communication via wired or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

Input/output devices 450 may, in some embodiments, include one or more display terminals, keyboards, keypads, touchpads, scanning devices, voice or optical recognition devices, or any other devices suitable for entering or accessing data by one or more computer systems 400. Multiple input/output devices 450 may be present in computer system 400 or may be distributed on various nodes of computer system 400. In some embodiments, similar input/output devices may be separate from computer system 400 and may interact with one or more nodes of computer system 400 through a wired or wireless connection, such as over network interface 440.

In some embodiments, the illustrated computer system may implement any of the methods described above, such as the methods illustrated by the flowchart of FIG. 3. In other embodiments, different elements and data may be included.

Those skilled in the art will appreciate that computer system 400 is merely illustrative and is not intended to limit the scope of embodiments. In particular, the computer system and devices may include any combination of hardware or software that can perform the indicated functions of various embodiments, including computers, network devices, Internet appliances, PDAs, wireless phones, pagers, and the like. Computer system 400 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 400 may be transmitted to computer system 400 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or DVD/CD-ROM, volatile or non-volatile media such as RAM (e.g., SDRAM, DDR, RDRAM, SRAM, and the like), ROM, and the like.

The methods described herein may be implemented in software, hardware, or a combination thereof, in different embodiments. In addition, the order of methods may be changed, and various elements may be added, reordered, combined, omitted or otherwise modified. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

While the foregoing is directed to embodiments of the present invention, other and further embodiments of the invention may be devised without departing from the basic scope thereof, and the scope thereof is determined by the claims that follow.

1. A computer-implemented method for managing dropped call operations, comprising:
receiving a first notification of a change in network connectivity during a communication session between a first user device and a second user device;
receiving a second notification of a change in network connectivity;
generating communication data for the communication session based on a time that the first notification of a change in network connectivity was received; and
transmitting the communication data to a service provider.

2. The method of claim 1, wherein the first notification of a change in network connectivity identifies that network connectivity to the first user device is lost.

3. The method of claim 1, wherein the first notification of a change in network connectivity indicates a disconnection of the communication session between the first user device and the second user device.

4. The method of claim 3, further comprising storing a time associated with the first notification of a change in network connectivity.

5. The method of claim 1, wherein the first notification and the second notification are received by a Voice over Internet Protocol (VoIP) telecommunication application disposed on the first user device.

6. The method of claim 1, wherein the second notification of a change in network connectivity identifies that network connectivity to the first user device is restored.

7. The method of claim 1, wherein the communication session is a Session Initiation Protocol (SIP) session.

8. The method of claim 1, wherein the communication session is established using a Voice over Internet Protocol (VoIP) telecommunication application disposed on a first user device.

9. The method of claim 1, wherein generating communication data comprises:
identifying one or more communications that had an active status when the first notification was received; and
identifying for each of the identified one or more communications at least one of a start time of the communication, an end time of the communication, a length of the communication, a dialed number, a communication identifier, a caller number, or a callee number.

10. The method of claim 9, further comprising at least one of prompting a user of the first user device to redial at least one of the identified one or more communications or prompting the first user device to auto-redial at least one of the identified one or more communications.

11. The method of claim 1, further comprising:
receiving an acknowledgement response from the service provider; and
deleting data regarding one or more communication sessions that had an active status when the first notification was received.

12. A computer-implemented method for managing dropped call operations comprising:
receiving communication data for at least one dropped communication from a user device;
verifying the at least one dropped communication has an active status; and
at least one of tearing down the at least one dropped communication, removing the at least one communications from a list of active communications in a current communications memory, or providing billing information for a communication session associated with the at least one dropped communication to a billing server.

13. The method of claim 12, wherein the communication data comprises at least one of a start time of the communication session, an time when network connectivity was lost during the communication session, a length of the communication, a dialed number, a communication identifier, a caller number, or a callee number for each of the at least one dropped communications.

14. The method of claim 12, wherein providing billing information comprises providing an end time of the communication session associated with when the communication data was received.

15. The method of claim 12, wherein providing billing information comprises providing an end time of the communication session associated with a time when network connectivity was lost during the communication session.

16. A system for managing dropped call operations, comprising:
a mobile application configured to:
receive a first notification of a change in network connectivity during a communication session between a first user device and a second user device;
receive a second notification of a change in network connectivity;
generate communication data for the communication session based on a time that the first notification of a change in network connectivity was received; and
transmit the communication data to a service provider.

17. The system of claim 16, wherein the first notification of a change in network connectivity identifies that network connectivity to the first user device is lost, and wherein the second notification of a change in network connectivity identifies that network connectivity to the first user device is restored.

18. The system of claim 16, wherein the first notification of a change in network connectivity indicates a disconnection of the communication session between the first user device and the second user device.

19. The system of claim 16, wherein the communication session is established using a Voice over Internet Protocol (VoIP) telecommunication application disposed on a first user device, and the communication session is a Session Initiation Protocol (SIP) session.

20. The system of claim 16, wherein generating communication data comprises:
identifying one or more communications that had an active status when the first notification was received; and
identifying for each of the identified one or more communications at least one of a start time of the communication, an end time of the communication, a length of the communication, a dialed number, a communication identifier, a caller number, or a callee number.
